(19) United States
(12) Patent Application Publication
(10) Pub. No.: US 2018/0031842 A1
(43) Pub. Date: Feb. 1, 2018

(54) HEAD-MOUNTED DISPLAY

(71) Applicant: Coretronic Corporation, Hsin-Chu (TW)

(72) Inventors: Chih-Hsien Tsai, Hsin-Chu (TW); Haw-Woei Pan, Hsin-Chu (TW); Chi-Tang Hsieh, Hsin-Chu (TW); Yi-Hsuang Weng, Hsin-Chu (TW)

(73) Assignee: Coretronic Corporation, Hsin-Chu (TW)

(21) Appl. No.: 15/659,648

(22) Filed: Jul. 26, 2017

(30) Foreign Application Priority Data
Jul. 28, 2016 (CN) 201610606220.8

(51) Int. Cl. G02B 27/01; G06F 1/16

(52) U.S. Cl. CPC G02B 27/0172; G02B 27/0176; G06F 1/1637; G06F 1/1684; G06T 19/006

(57) ABSTRACT

A head-mounted display including an apparatus body and an image display device is provided. The apparatus body includes a first part and a second part connected to the first part. The image display device is disposed at the apparatus body and adapted to project a display image to a projection target. The image display device includes a fiber element and an imaging element. The fiber element is adapted to transmit an illumination beam. The imaging element is adapted to project the image beam to the projection target to display the display image. The fiber element is disposed at the first part of the apparatus body. The imaging element is disposed at one of the first part and the second part of the apparatus body. The head-mounted display is capable of expanding the user's field of view and reducing the size and weight.

### CROSS-REFERENCE TO RELATED APPLICATION

This application claims the priority benefit of China application serial no. 201610606220.8, filed on Jul. 28, 2016. The entirety of the above-mentioned patent application is hereby incorporated by reference herein and made a part of this specification.

### BACKGROUND OF THE INVENTION

### Field of the Invention

The invention relates to a display, and particular relates to a head-mounted display.

### Description of Related Art

Near eye displays (NED) or head-mounted displays (HMD) are currently considered to be wearable displays that are full of potential. The NEDs are divided into the augmented reality (AR)-type and virtual reality (VR)-type based on whether an image of the surroundings is also seen in actual use. Virtual reality emphasizes the sense of reality in a virtual world, namely a wide field of view that exceeds the extreme of human eyes. Augmented reality, on the other hand, focuses on providing the best image quality under the premise of making an apparatus more light-weighted. Currently, the key to the development of optical technologies for AR-type head-mounted displays is how the crucial requirements, namely field of view (FOV), size, weight, and appearance, are taken into consideration at the same time.

The information disclosed in this “Description of Related Art” section is only for enhancement understanding of the background of the invention and therefore it may contain information that does not form the prior art that is already known to a person of ordinary skilled in the art. Furthermore, the information disclosed in this “Description of Related Art” section does not mean that one or more problems to be solved by one or more embodiments of the invention were acknowledged by a person of ordinary skill in the art.

### SUMMARY OF THE INVENTION

The invention provides a head-mounted display capable of expanding the user's field of view (FOV) and reducing a size and weight.

The invention provides a head-mounted display that is comfortable to wear.

Other objects and advantages of the invention can be further illustrated by the technical features broadly embodied and described as follows.

In order to achieve one or a part of or all of the objects or other objects, an embodiment of the invention is directed to a head-mounted display including an apparatus body and an image display device. The apparatus body includes a first part and a second part, and the second part is connected to the first part. The image display device is disposed at the apparatus body. The image display device is adapted to project a display image to a projection target. The image display device includes a fiber element and an imaging element. The fiber element is adapted to transmit an illumination beam. The imaging element is adapted to project an image beam to the projection target to display the display image. The fiber element is disposed at the first part of the apparatus body. The imaging element is disposed at one of the first part and the second part of the apparatus body.

Based on the above, the embodiments of the invention at least have one of the following advantages or effects. In the image display device according to the embodiments of the invention, the illumination beam required by the image display device to display the display image is transmitted by the fiber element, therefore the appearance of the head-mounted display is fashionable and the head-mounted display is comfortable to wear. Moreover, in the embodiment of the invention, the head-mounted display is also capable of expanding the user's field of view (FOV) and has a reduced size and weight.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view illustrating a head-mounted display according to an embodiment of the invention.

FIG. 2 is a schematic view illustrating a head-mounted display according to another embodiment of the invention.

FIG. 3 is an optical schematic view illustrating an image display device according to an embodiment of the invention.

FIG. 4 is a schematic view illustrating a light emitting element outputting an illumination beam to a fiber element according to an embodiment of the invention.

FIGS. 5 and 6 are schematic cross-sectional views illustrating cross-sections of fiber elements according to different embodiments of the invention.

FIGS. 7 and 8 are schematic side views illustrating light collimating elements according to different embodiments of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

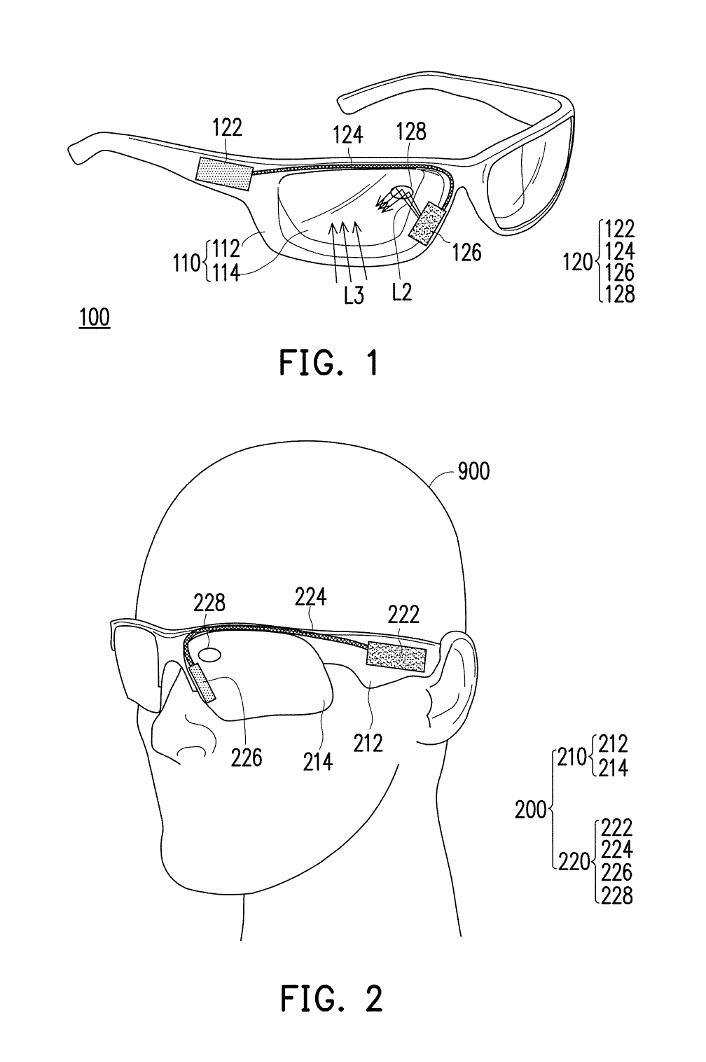

FIG. 1 is a schematic view illustrating a head-mounted display according to an embodiment of the invention. Referring to FIG. 1, a head-mounted display 100 of the embodiment includes an apparatus body 110 and an image display device 120. In the embodiment, the apparatus body 110 includes a first part 112 and a second part 114, and the second part 114 is connected to the first part 112. In the embodiment, the apparatus body 110 includes spectacles (glasses), for example. However, the type and configuration of the spectacles (glasses) shall not be construed as limitations on the invention. In the embodiment, the first part 112 includes at least one of a frame, a holder, and a hose pad. In the embodiment, the frame, the holder, and the nose pad may be separately manufactured and then assembled by using a screw or a similar fixer, for example. In an embodiment, the frame, the holder, and the nose pad may also be integrally formed. The invention does not intend to impose a limitation on the type and configuration of the apparatus body. In the embodiment, the second part 114 includes a glass. In the embodiment, the number of the glass may be one or two, for example, and the glass(es) may be assembled on the frame. In other embodiments, the first part 112 and the second part 114 may be integrally formed. For example, the first part 112 and the second part 114 may be integrally formed to be a goggle structure.

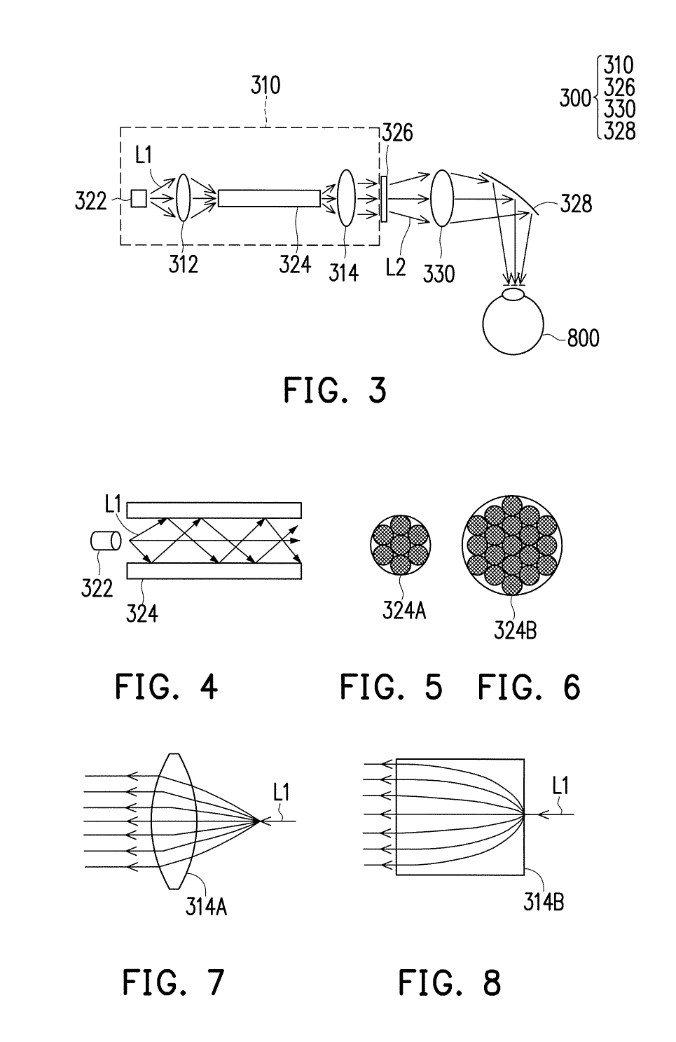

In the embodiment, the image display device 120 is disposed at the apparatus body 110. In the embodiment, the image display device 120 is adapted to project a display image to a projection target by virtual image projection. In the embodiment, the projection target is a user's eye (e.g., a projection target 800 shown in FIG. 3), for example. In other words, in the embodiment, the display image that the user's eye sees is presented as an enlarged virtual image.

In the embodiment, the image display device 120 includes a light emitting element 122, a fiber element 124, an image output element 126, and an imaging element 128. In the embodiment, the light emitting element 122, the fiber element 124, and the image output element 126 are disposed at the first part 112 of the apparatus body 110. For example, the light emitting element 122 may be disposed at at least one of the frame and the holder of the spectacles (glasses). In the embodiment, the image output element 126 may be disposed at at least one of the frame and the nose pad of the spectacles (glasses). In the embodiment, the fiber element 124 may be disposed at at least one of the frame, the holder, and the nose pad of the spectacles (glasses). The fiber element 124 may extend linearly in a predetermined direction of the frame of the spectacles (glasses) or extend as a curved line or a folding line in a plurality of different directions of the frame of the spectacles (glasses), for example. The invention does not intend to impose a limitation on the arrangement of the fiber element with respect to the first part of the apparatus body. In the embodiment, the imaging element 128 is disposed in one of the first part 112 and the second part 114 of the apparatus body 110. For example, the imaging element 128 may be integrated to the glass of the spectacles (glasses) or located at an inner side of the glass and tightly attached to the glass.

In the embodiment, the light emitting element 122 is adapted to output an illumination beam (e.g., an illumination beam L1 shown in FIG. 3) to the fiber element 124. In the embodiment, the fiber element 124 is adapted to transmit the illumination beam from the light emitting element 122 to the image output element 126. In the embodiment, the image output element 126 is adapted to modulate the illumination beam L1 to form an image beam L2, and output the image beam L2 to the imaging element 128. In the embodiment, the imaging element 128 is adapted to project the image beam L2 to the projection target by virtual image projection for displaying the display image. Namely, in the embodiment, the fiber element 124 is adapted to transmit the illumination beam L1, and the imaging element 128 is adapted to project the image beam to the projection target for displaying the display image. In the embodiment, an ambient beam L3 is adapted to pass through the second part 114 of the apparatus body 110 and be projected to the projection target, for example, such that the head-mounted display 100 is enabled to provide an augmented reality (AR) function. However, the method of transmitting the illumination beam by the fiber element 124 according to the embodiment of the invention may also be used in a head-mounted display for virtual reality (VR) or mixed reality (MR). The invention does not intend to impose a limitation on the applicability of the fiber element.

In the embodiment, the fiber element 124 is used in the head-mounted display 100 as a transmitting medium of the illumination beam L1 between the light emitting element 122 and the image output element 126. In the embodiment, the light emitting element 122 is disposed at the frame of the spectacles (glasses) near the user's ear, for example. However, the invention is not limited thereto. In the embodiment, after the illumination beam L1 emitted by the light emitting element 122 is coupled to the fiber element 124, the fiber element 124 is arranged to extend to the nose pad of the spectacles (glasses) near the user's nasal bridge along the frame of the spectacles (glasses) by utilizing a flexible characteristic of the fiber 124, so as to transmit the illumination beam L1 to the image output element 126. Besides, in an embodiment, the frame of the spectacles (glasses) may serve to enclose/cover the fiber element 124, the fiber element 124 is embedded in the frame of the spectacles (glasses) in the first part 112 of the apparatus body 110, and the head-mounted display 110 may look like a normal pair of glasses.

However, it should be understood that the invention does not intend to impose a limitation on the type and configuration of the apparatus body (e.g., spectacles, glasses). FIG. 2 is a schematic view illustrating a head-mounted display according to another embodiment of the invention. Referring to FIGS. 1 and 2, a head-mounted display 200 of the embodiment is similar to the head-mounted display 100 in the embodiment shown in FIG. 1. The difference therebetween mainly lies in the configuration of an apparatus body 210. For example, in the embodiment, a first part 212 of the apparatus body 210 does not completely enclose/cover the edge of a second part 214.

Referring to FIG. 2, in the embodiment, a light emitting element 222 and an image output element 226 are respectively disposed at two different positions away from each other of the frame of the spectacles (glasses). In the embodiment, by utilizing the flexible characteristic of an fiber element 224, the fiber element 224 may extend along the frame of the spectacles (glasses) in the head-mounted display 200, such that the illumination beam L1 emitted by the light emitting element 222 at the frame of the spectacles (glasses) near the ear of a user 900 may be transmitted to the image output element 226 at the nose pad of the spectacles (glasses) near the nasal bridge. In the embodiment, by moving the light emitting element 222 to the frame of the spectacles (glasses) near the ear, a space around the nose pad of the spectacles (glasses) near the nasal bridge may be less crowded. In the embodiment, since the light emitting element 222 and the image output element 226 are disposed at two different positions near the frame and the nose pad of the spectacles (glasses), the weights of the light emitting element 222 and the image output element 226 are respectively carried by the user's ear and nasal bridge. Thus, in the embodiment, the weight of the head-mounted display 200 is evenly distributed, thereby making the heat-mounted display 200 comfortable to wear. In the embodiment, the imaging element 238 is integrated to the glass of the spectacles (glasses), or the imaging element 238 is located at the inner side of the glass and tightly attached to the glass, and the fiber element 224 transmitting the illumination beam may be enclosed/covered in the frame of the spectacles (glasses) for example, so the appearance of the head-mounted display 200 is fashionable and the awkwardness/exaggeration of the head-mounted display 200 is reduced.

Besides, in the embodiment, the descriptions of the embodiment shown in FIG. 1 have provided sufficient teaching, suggestions, and explanations for embodiment concerning the locations and operations of the respective components in the head-mounted display 200 of the embodiment. Thus, details in these regards will not be reiterated below.

FIG. 3 is an optical schematic view illustrating an image display device according to an embodiment of the invention. Referring to FIG. 3, an image display device 300 of the embodiment includes a light source module 310, an image output element 326, a lens element 330 (second lens element), and an imaging element 328. In the embodiment, the light source module 310 includes a light emitting element 322, a lens element 312 (first lens element), a fiber element 324, and a light collimating element 314. In the embodiment, the lens element 312 is disposed between the light emitting element 322 and the fiber element 324 on a transmitting path of the illumination beam L1. The light collimating element 314 is disposed between the fiber element 324 and the image output element 326 on the transmitting path of the illumination beam L1. The lens element 330 is disposed between the image output element 326 and the imaging element 328 on a transmitting path of the image beam L2.

Specifically, in the embodiment, the light emitting element 322 is adapted to output the illumination beam L1 to the lens element 312. In the embodiment, the lens element 312 is adapted to focus the illumination beam L1 on the fiber element 324. In the embodiment, the fiber element 324 is adapted to transmit the illumination beam L1 from the lens element 312 to the light collimating element 314. Then, in the embodiment, the light collimating element 314 is adapted to collimate the illumination beam and transmit the collimated illumination beam L1 to the image output element 326. In the embodiment, the image output element 326 is adapted to output the image beam L2 to the lens element 330 according to/based on the illumination beam L1. In the embodiment, the lens element 330 then is adapted to focus the image beam L2 on the imaging element 328. In the embodiment, the imaging element 328 is adapted to project the image beam L1 to the projection target 800 by virtual image projection for displaying the display image. In the embodiment, the projection target 800 is the user's eye, for example.

In the embodiment, the image display device 300 is disposed at the corresponding apparatus body in a way similar to that shown in the head-mounted display 100 or 200 in FIG. 1 or 2. For example, in the embodiment, with respect to the light collimating element 314, the light emitting element 322 and the lens element 312 are collectively disposed at a first position of the first part of the apparatus body thereof, for example, such as the frame of the spectacles (glasses) near the user's ear. In the embodiment, with respect to the light emitting element 322 and the lens element 312, the collimating element 314 and the image output element 326 are collectively disposed at a second position of the first part of the apparatus body, for example, such as the nose pad of the spectacles (glasses) near the user's nasal bridge. In the embodiment, as shown in the head-mounted display 100 or 200 in FIG. 1 or 2, the fiber element 324 may extend as a curve, for example, in a plurality of different directions of the apparatus body, so as to optically couple the lens element 312 and the light collimating element 314. In an embodiment, the fiber element 324 may also extend as a folding line, for example, in a plurality of different directions of the apparatus body, so as to optically couple the lens element 312 and the light collimating element 314. Alternatively, in an embodiment, the fiber element 324 may also extend linearly in a predetermined direction of the apparatus body, so as to optically couple the lens element 312 and the light collimating element 314.

In the embodiment, the lens element 312 and the lens element 330 may be a variety of lens elements or a combination thereof, such as a lens, a mirror, a curve mirror, a prism, a mirror-prism, a mirror-lens, or a prism-lens. The invention does not intend to impose a limitation on the types of the lens element. In addition, the locations and operations of the other/respective components of the image display device 300 of the embodiment may be referred to the descriptions of the embodiments shown in FIGS. 1 and 2.

FIG. 4 is a schematic view illustrating a light emitting element outputting an illumination beam to a fiber element according to an embodiment of the invention. Referring to FIGS. 3 and 4, the image display device 300 is taken as an example. For a concise description, FIG. 4 only illustrates the light emitting element 322 and the fiber element 324, and the light emitting element 322 is disposed directly at an input end of the fiber element 324. In the embodiment, the light emitting element 322 may operate synchronously with the image output element 326 under the control of an electronic circuit (not shown) in addition to providing the illumination beam L1 to the image output element 326. In the embodiment, the light emitting element 322 may be a light emitting diode (LED), a laser diode (LD), or other photoelectronic elements that are miniaturized and able to emit light, for example. The invention does not intend to impose a limitation on the type of the light emitting element.

Referring to FIG. 3 again, in the embodiment, the illumination beam L1 emitted by the light emitting element 322 is dispersed/divergent light and focuses on the input end of the fiber element 324 through the lens element 312, so as to increase the optical coupling efficiency of the illumination beam L1 entering the fiber element 324. In the embodiment, the fiber element 324 is adapted to transmit the illumination beam L1 to the image output element 326 from an output end of the fiber element 324. In the embodiment, the fiber element 324 is a multimode fiber, for example. In the embodiment, the transmission of the illumination beam L1 in the multimode fiber is as shown in FIG. 4. In the embodiment, a core inside the fiber element 324 is formed with a material having a high refractive index, and a cladding enclosing/covering an outer layer of the core is formed with a material having a low refractive index. Thus, the illumination beam L1 may have total reflection at an interface between the core and the cladding, and the illumination beam L1 in the core is thus transmitted through repetitive/continual total reflection.

FIGS. 5 and 6 are schematic cross-sectional views illustrating cross-sections of fiber elements according to different embodiments of the invention. Referring to FIGS. 4 to 6, in an exemplary embodiment of the invention, a diameter of the core of the multimode fiber is in a range from 50 micrometers to 125 micrometers, for example, and the diameter of the core is a single fiber diameter. In the embodiment, the fiber element 324 includes a plurality of fiber bundles, for example, and a cross-section of the fiber element 324 may be an optical fiber array 324A or 324B shown in FIGS. 5 and 6. In the embodiment, a structure of such fiber bundle is able to increase a light receiving area when the illumination beam L1 is coupled to the fiber element 324. However, the invention does not intend to impose a limitation on the type of the fiber element.

FIGS. 7 and 8 are schematic side views illustrating light collimating elements according to different embodiments of the invention. Referring to FIGS. 4, 7, and 8, in an exemplary embodiment of the invention, the light collimating element 314 is disposed between the fiber element 324 and the image output element 326 to adjust a distribution of a light shape of the illumination beam L1 entering the image output element 326, so that at least the distribution of the light shape of the illumination beam L1 output by the fiber element 324 meets a requirement of the image output element 326. In the embodiment, the light collimating element 314 may be in a configuration of a collimating lens shown in FIG. 7 or a gradient reflective index (GRIN) lens shown in FIG. 8, for example. The invention does not intend to limit the type of the light collimating element. For example, the light collimating element 314 may be a Fresnel lens or a liquid crystal lens.

In view of the above, the embodiments of the invention at least have one of the following advantages or effects. In the image display device according to the embodiments of the invention, the illumination beam required by the image display device to display the display image is transmitted by the fiber element. In the embodiment of the invention, by utilizing the flexible characteristic of the fiber element, the fiber element may extend on the apparatus body, so as to optically couple the light emitting element and the image output element at different locations. In the embodiment of the invention, such configuration may reduce the crowdedness caused by a collective arrangement of the optical components on the apparatus body, and the weights of the components are also carried/shared by different parts of the user. Thus, in the embodiment of the invention, the weight of the head-mounted display is evenly distributed, thereby making the heat-mounted display comfortable to wear. In addition, in the embodiment of the invention, the imaging element is integrated to the glass of the spectacles (glasses), or the imaging element is located at the inner side of the glass and tightly attached to the glass, and the fiber element transmitting the illumination beam may be enclosed/covered in the frame of the spectacles (glasses), so the appearance of the head-mounted display is fashionable and the awkwardness/exaggeration of the head-mounted display is reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A head-mounted display, comprising:
an apparatus body, comprising a first part and a second part, wherein the second part is connected to the first part; and
an image display device, disposed at the apparatus body, adapted to project a display image to a projection target, and comprising:
a fiber element, adapted to transmit an illumination beam; and
an imaging element, adapted to project an image beam to the projection target to display the display image,
wherein the fiber element is disposed at the first part of the apparatus body, and the imaging element is disposed at one of the first part and the second part of the apparatus body.

2. The head-mounted display as claimed in claim 1, wherein the image display device further comprises a light emitting element and an image output element, the light emitting element is adapted to output the illumination beam to the fiber element, the fiber element is adapted to transmit the illumination beam from the light emitting element to the image output element, the image output element is adapted to modulate the illumination light beam to form the image beam and output the image beam to the imaging element, and the imaging element is adapted to project the image beam by virtual image projection to the projection target for displaying the display image, wherein the light emitting element and the image output element are disposed at the first part of the apparatus body.

3. The head-mounted display as claimed in claim 2, wherein the light emitting element and the fiber element are formed to be a light source module, and the light source module further comprises:
a first lens element, disposed on a transmitting path of the illumination beam, disposed between the light emitting element and the fiber element, and adapted to focus the illumination beam on the fiber element; and
a light collimating element, disposed on the transmitting path of the illumination beam, disposed between the fiber element and the image output element, adapted to collimate the illumination beam, and adapted to transmit the collimated illumination beam to the image output element.

4. The head-mounted display as claimed in claim 3, wherein the light emitting element and the first lens element are collectively disposed at a first position of the first part of the apparatus body with respect to the light collimating element, and the light collimating element and the image output element are collectively disposed at a second position of the first part of the apparatus body with respect to the light emitting element and the first lens element.

5. The head-mounted display as claimed in claim 3, wherein the fiber element extends linearly in a predetermined direction for optically coupling the first lens element and the light collimating element.

6. The head-mounted display as claimed in claim 3, wherein the optical element extends as a curved or folding line in a plurality of directions, and the fiber element optically couples the first lens element and the light collimating element.

7. The head-mounted display as claimed in claim 2, wherein the image display device further comprises a second lens element, the second lens element is disposed on a transmitting path of the image beam and between the image output element and the imaging element, and the second lens element is adapted to focus the image beam on the imaging element.

8. The head-mounted display as claimed in claim 1, wherein an ambient beam is adapted to pass through the second part of the apparatus body and be projected to the projection target.

9. The head-mounted display as claimed in claim 1, wherein the apparatus body comprises spectacles, the second part comprises a glass, and the first part comprises at least one of a frame, a holder, and a nose pad.

10. The head-mounted display as claimed in claim 9, wherein the fiber element is disposed at at least one of the frame and the holder.
